(19) United States
(12) Patent Application Publication
(10) Pub. No.: US 2010/0268599 A1
(43) Pub. Date: Oct. 21, 2010

(54) METHOD AND SYSTEM FOR PROACTIVELY AND REMOTELY TRIGGERING APPLICATIONS FOR MARKETING CAMPAIGNS ON MOBILE DEVICES

(75) Inventor: Domingo López Montesdeoca, Madrid (ES)

Correspondence Address: FOLEY HOAG, LLP;PATENT GROUP, WORLD TRADE CENTER WEST, 155 SEAPORT BLVD, BOSTON, MA, 02110, US

(73) Assignee: MOVIDILO S.L., Madrid (ES)

(21) Appl. No.: 12/470,881

(22) Filed: May 22, 2009

Related U.S. Application Data
(60) Provisional application No. 61/171,304, filed on Apr. 21, 2009.

(51) Int. Cl. G06Q 30/00; H04M 3/42

(52) U.S. Cl. 705/14.52; 455/414.1; 705/14.64

(57) ABSTRACT

A method and system are provided of using a server computer system for conducting a marketing campaign directed at users of mobile communications devices, the method includes: (a) identifying a targeted subset of the users of the mobile communications devices based on their user profiles to receive and execute a given one of a plurality of interactive marketing applications; and (b) for each of the targeted subset of users: (i) transmitting a signal with initial information relating to an application over a wireless communications network to a mobile communications device operated by the user to proactively launch the given one of the interactive marketing applications on the mobile communications device; and (ii) establishing bidirectional communications between the user and an entity conducting the marketing campaign responsive to user interaction with the interactive marketing application.

### RELATED APPLICATION

This application claims priority from U.S. Provisional Patent Application No. 61/171,304, filed on Apr. 21, 2009, entitled Method and System for Proactively and Remotely Triggering Applications for Marketing Campaigns on Mobile Devices, which is hereby incorporated by reference.

### BACKGROUND

The present application relates generally to mobile communications devices, and, more particularly, to methods and systems for proactively and remotely triggering applications for marketing campaigns on such devices.

### BRIEF SUMMARY OF EMBODIMENTS OF THE INVENTION

In accordance with one or more embodiments, a method is provided of using a server computer system for conducting a marketing campaign directed at users of mobile communications devices. The method includes the steps of: (a) identifying a targeted subset of the users of the mobile communications devices based on their user profiles to receive and execute a given one of a plurality of interactive marketing applications; and (b) for each of the targeted subset of users: (i) transmitting a signal with initial information relating to an application over a wireless communications network to a mobile communications device operated by the user to proactively launch the given one of the interactive marketing applications on the mobile communications device; and (ii) establishing bidirectional communications between the user and an entity conducting the marketing campaign responsive to user interaction with the interactive marketing application.

In accordance with one or more embodiments, a system is provided for conducting a marketing campaign directed at users of mobile communications devices. The system includes a server communicating with the mobile communications devices over a wireless network. The server identifies a targeted subset of the users of the mobile communications devices based on their user profiles to receive and execute a given one of a plurality of interactive marketing applications. For each of the targeted subset of users, the server (i) transmits a signal with initial information relating to an application over the wireless communications network to a mobile communications device operated by the user to proactively launch the given one of the interactive marketing applications on the mobile communications device; and (ii) establishes bidirectional communications between the user and an entity conducting the marketing campaign responsive to user interaction with the interactive marketing application.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

FIG. 1 is a simplified block diagram of a wireless communications system in accordance with one or more embodiments of the invention.

FIG. 2 is an exemplary screenshot illustrating content displayed on a mobile device from a marketing application.

FIG. 3 is a flow chart illustrating operation of an exemplary mobile marketing campaign in accordance with one or more embodiments of the invention.

FIG. 4 is an exemplary screenshot illustrating content displayed on a mobile device from a marketing application.

FIG. 5 is an exemplary screenshot illustrating content displayed on a mobile device from a marketing application.

FIG. 6 is an exemplary screenshot illustrating content displayed on a mobile device from a marketing application.

FIG. 7 is an exemplary screenshot illustrating content displayed on a mobile device from a marketing application.

### DETAILED DESCRIPTION

Various embodiments of the invention are directed to methods and systems for conducting marketing campaigns by proactively and remotely triggering interactive marketing applications on mobile communications devices. The interactive marketing applications can be used for a variety of purposes including campaigns, promotions and any type of marketing and sales efforts. The interactive marketing applications can be provided to the mobile devices and triggered remotely by a server over a wireless network. The system allows marketing campaigns to be targeted to selected groups of users with personalized content presented to individual users.

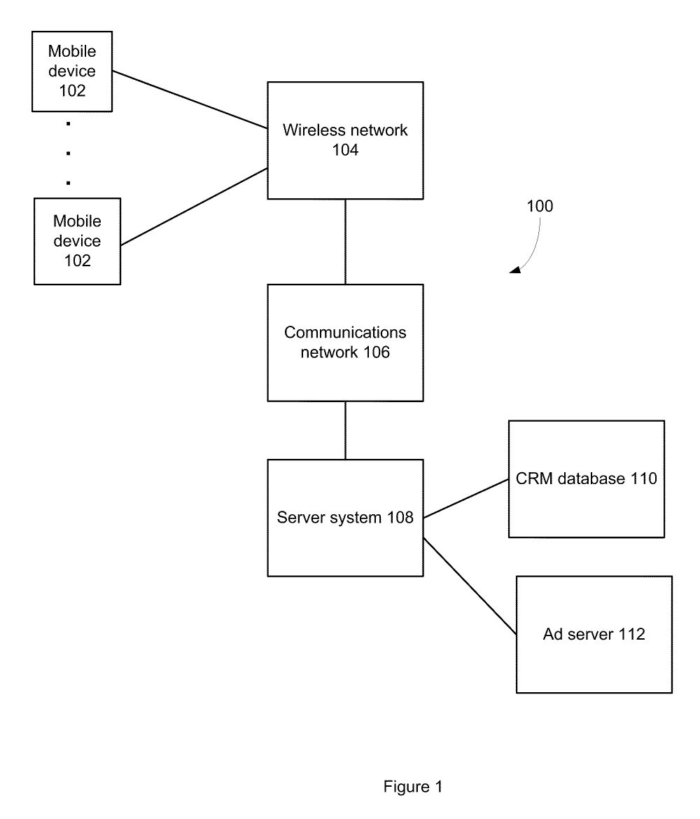

FIG. 1 is a simplified block diagram of an exemplary communications system in which various embodiments of the invention can be implemented. The system includes a plurality of mobile devices 102, a wireless data network 104, a communications network 106, and a server system 108. The server system 108 can communicate with backend systems such as customer relationship management (CRM) databases 110, which can store user profile information, and Ad servers 112 (or content management systems (CMS), or other marketing campaign management systems), which can store content for the interactive marketing applications.

The mobile devices 102 can include a variety of portable computing devices capable of connecting to other computing devices and transmitting and receiving information. The mobile device 102 transmits information to and receives information from the server system 108 via the wireless data network 104 and the communications network (e.g., the Internet) 106. Examples of mobile devices 102 include portable devices such as, e.g., cellular telephones, smartphones, and the like.

Each mobile device 102 includes mobile client software (available, e.g., from MOVIDILO SL), which is client software that facilitates downloading of rich multimedia applications from the server system 108 and execution of applications on the mobile device. The mobile client software on the mobile devices 102 and software on the server system 108 comprise a mobile services platform, which facilitates delivery and execution of applications on the mobile devices. The client software runs on a resident operating system such as, e.g., Symbian, Windows Mobile, Android, or a proprietary operating system. The operating system controls the mobile device and interacts with the hardware controlling access to the file system, memory, the central processing unit, transmission channels, and allocating resources. The mobile client software includes an execution environment layer for running rich multimedia applications regardless of the underlying operating system.

The wireless data network 104 is configured to couple mobile devices 102 with the communications network 106. The wireless data network 104 can include any of a variety of networks including cellular communications networks, mesh networks, Wireless LAN (WLAN) networks, and the like. The wireless data network can further employ a plurality of access technologies including 2nd (2G), 3rd (3G) generation radio access for cellular systems, WLAN, Wireless Router (WR) mesh, and the like. Access technologies such as 2G, 3G, and future access networks can provide wide area coverage for mobile devices 102. For example, wireless data networks 104 can provide a radio connection through a radio network access such as Universal Mobile Telecommunications System (UMTS), Global System for Mobile communication (GSM), General Packet Radio Services (GPRS), Enhanced Data GSM Environment (EDGE), Wideband Code Division Multiple Access (WCDMA), Code Division Multiple Access (CDMA), and the like. In short, the wireless data network 104 can include virtually any wireless communication mechanism by which information may travel between mobile device 102 and another computing device, network, and the like, without limitation to any of the examples identified above.

The communications network 106 is configured to couple the server system 108 with other computing devices, including mobile devices 102, through the wireless network 104. The communications network 106 can be, e.g., the Internet, an intranet, or other network connection.

The mobile device 102 and the server system 108 can communicate using various communications protocols including, e.g., Hypertext Transfer Protocol (HTTP) or HTTPS, User-Datagram Protocol (UDP).

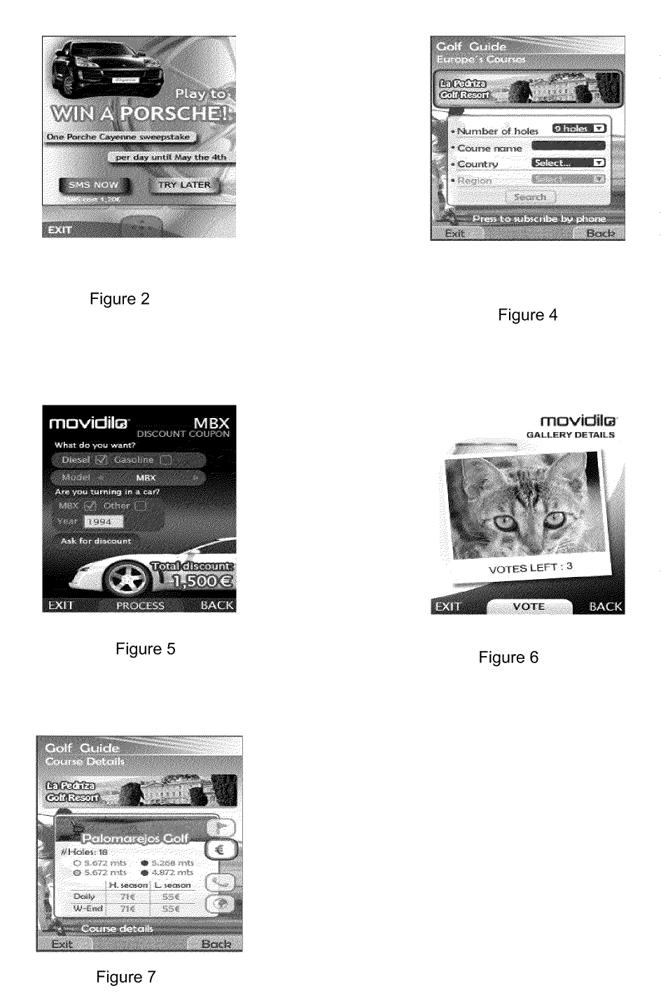

As will be described in further detail below, the marketing system allows implementation of personalized marketing campaigns targeted to particular users of mobile devices. A targeted subset of mobile device users can be selected based on their user profiles to receive a particular interactive marketing application. For each of the targeted users, the server system sends a signal to the user (which can be, e.g., an SMS message), in silent mode, which launches the client software stored on the mobile device. The client software, in turn, downloads and launches the interactive marketing application, and the user is presented with multimedia marketing material (such as an offer, promotion, a reminder to act on a promotion, or an alert) on the mobile device. For example, FIG. 2 illustrates an exemplary screenshot shown on the mobile device display of a marketing promotion inviting a user to participate in a sweepstakes.

The client software is launched in response to receiving the triggering signal, and can be inactive prior to receiving the signal in order to reduce memory usage or battery consumption.

Once the interactive marketing application is running, the user can directly interact with marketing campaign. For example, in the FIG. 2 screenshot, the user can make a selection to participate in the sweepstakes, not participate, or to defer action to a later time.

The interactive marketing applications are targeted to particular groups or subsets of mobile device users who are selected based on their personal profiles. For example, the interactive marketing application displayed in FIG. 2 might be directed to users whose profiles indicate that they have an interest in automobiles. The user profiles can be stored in backend systems such as the CRM databases 110, which can be operated by advertisers or other entities running the marketing campaign. User profile information may contain, but is not limited to, demographic data (such as the user's age and gender) and psychographic data, which reflects the user's interests (such as sports, movies, music, travel, and finance). User profile information can also include information on user preferences obtained from user responses to prior campaigns. Responses from user interaction with marketing actions can be relayed by the server 108 back to the corresponding CRM database 110 to be stored in the user profiles.

The user responses can result in other marketing actions, which are also triggered remotely, to create a bidirectional communication between the advertiser and mobile device user.

In some embodiments, the functional aspects of the interactive marketing applications can be stored on the server system 108, and at least some of the content (such as graphical images) for the applications can be stored on backend systems such as the ad server 112 operated by advertisers and the other entities conducting the marketing campaigns. The server 108 retrieves the content for the applications to be delivered to the mobile devices 102 from the backend systems. In this way, the content in the marketing campaigns can be more easily controlled and kept up-to-date by advertisers.

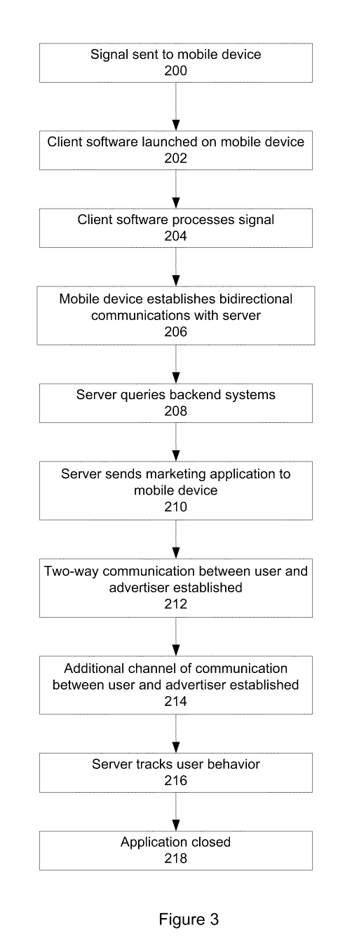

FIG. 3 is a simplified flowchart illustrating operation of an exemplary mobile marketing campaign in accordance with one or more embodiments.

In step 200, a signal (e.g., SMS message) is sent by the server to the mobile device to trigger launching of an interactive marketing application on the mobile device. The signal is preferably sent transparently to user, and does not remain in the user's inbox. (The client software on the on the mobile device, once activated, handles the message and usually deletes it.) The user is therefore unaware that the mobile device has received the signal. The mobile device can optionally receive the signal at a special designated port.

In step 202, in response to receiving the signal, the client software on the mobile device is loaded in memory and launched.

In step 204, the client software processes the signal. The signal can include initial information from the server and/or backend systems relevant for either the user or the client application to act upon. The information can be customized for groups of users or even individual users. The information can include, e.g., text for promotions, URLs (Uniform Resource Locators) to initiate subsequent connections, contact center telephone numbers as a parameter for a direct call, account balance details in the form of an alert.

In step 206, the mobile device establishes a bidirectional communication with the server.

In step 208, the server system queries the backend systems for segmentation and personalized content for the application.

In step 210, the server sends the interactive marketing application and associated content to the mobile device.

In step 212, a live two-way communication between the user and the advertiser or entity conducting the marketing campaign is established via the server system in response to user interaction with the marketing application.

In step 214, other channels of communication (e.g., a telephone call, an Internet connection, or a WAP connection) between the mobile device user and the entity conducting the marketing campaign can be established, if desired by the user. The other channels of communication can be easily established by the user. For example, the user can click on a single button on the mobile device display to establish a telephone call to a call center or receive information from a website. Thereafter, the user can return to the application on the mobile device, if desired.

The server system tracks user behavior, preferences, and responsiveness to interactive marketing applications, and in step 216, it sends this data to the backend systems to be stored in the user profile.

In step 218, the application is closed by the user, e.g., after the user has completed use of the application.

The marketing system thereby provides a proactive remote trigger mechanism that allows segmented and personalized marketing content to be pushed to a targeted audience according to a desired schedule. It also facilitates two-way communication in real time between mobile device users and advertisers in response to marketing campaigns. The remote trigger mechanism can trigger campaigns remotely and proactively without any action by the user.

The system allows segmented and personalized content to be sent to each mobile device user, which allows advertisers to effectively target and manage their marketing campaigns. In addition, by tracking user behavior, advertisers can adapt and target campaigns to particular consumer segments and individuals to improve acceptance and redemption results. Data on user behavior patterns from each user targeted by a campaign is relayed back to the advertiser. This data makes it easier to determine the effectiveness of a campaign based on, e.g., whether the advertising content been viewed and how often, what was found interesting by the user, or what promotions were accepted and redeemed. Advertisers can thereby fine tune campaigns to mobile device users and deliver more relevant marketing material to users.

The marketing campaigns can be launched in accordance with a predetermined schedule. For example, an interactive marketing application can be triggered periodically during some time period, e.g., during a summer sale event or the Christmas shopping season. As another example, an interactive marketing application can be triggered at particular times in the day, e.g., after work between 6-9 p.m. for restaurants taking dinner reservations. Marketing applications can also be triggered periodically to remind users that they may still participate in a marketing campaign, particularly if they had previously indicated a desire to respond to the campaign at a later time.

A response to a marketing campaign by a user may result in other applications being proactively launched on the user device. For example, if in response to an advertisement for a vacation package, the user makes a purchase, he or she may subsequently be offered travel insurance from a subsequent marketing application. As another example, if the user response to an offer to purchase a book, he or she may subsequently be offered a related book that might also be of interest. As another example, as shown in FIG. 4, if the user interacts with an application for locating a golf course, he or she may be presented with a promotion for a stay at a nearby hotel.

The marketing applications are interactive, allowing users to effectively engage with the promotion. For example, in the exemplary screenshot of FIG. 5, once the user selects his or her preference (in this case making a choice between diesel and gasoline fuel), the screen dynamically changes to display the appropriate promotion content. As another example, in the FIG. 6 screenshot, the user can participate in a photography popularity contest where a user is assigned a given number of votes. Once the user votes for a particular photograph, he or she is automatically notified of how many votes the user has remaining.

Preferences expressed by the user can be gathered and stored in the user's profile in the CRM database for use in targeting and personalizing future promotions.

As discussed above, in step 214, other channels of communication can be established between the mobile device user and the entity conducting the marketing campaign through the mobile device. For example, a telephone connection can be established to allow a user to speak with a customer care agent to resolve query, finalize a booking, etc. As shown in the exemplary screenshot of FIG. 7, a user can select a telephone icon displayed by the interactive marketing application in order to initiate a telephone call with a reservations agent. In another example, the mobile device can be connected to a web page or an LBS (location-based system) to, e.g., find the nearest merchant for a particular product or service. Additionally, multimodal communication can be used, e.g., the user can conduct a search using voice commands.

Once communication on this additional channel has been completed, the marketing application can be returned to its last state.

Marketing campaigns typically have a limited lifespan, and content for the interactive marketing applications typically have a short shelf-life. In the marketing system described herein, campaigns can be automatically updated in real-time transparently to the user. Campaign messages can be proactively changed according to the advertiser's strategy based on various criteria. For example, campaigns may be terminated after a specified period of time. Also, offers that have been redeemed or otherwise responded to by a user are not presented again to the user.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, e.g., in hardware, software, firmware, or any combination thereof.

Claims set forth below having steps that are numbered or designated by letters should not be considered to be necessarily limited to the particular order in which the steps are recited.

Having described preferred embodiments of the present invention, it should be apparent that modifications can be made without departing from the spirit and scope of the invention.

What is claimed is:

1. A method using a server computer system of conducting a marketing campaign directed at users of mobile communications devices, the method comprising:
(a) identifying a targeted subset of the users of the mobile communications devices based on their user profiles to receive and execute a given one of a plurality of interactive marketing applications; and
(b) for each of the targeted subset of users:
(i) transmitting a signal with initial information relating to an application over a wireless communications network to a mobile communications device operated by the user to proactively launch the given one of the interactive marketing applications on the mobile communications device; and
(ii) establishing bidirectional communications between the user and an entity conducting the marketing campaign responsive to user interaction with the interactive marketing application.

2. The method of claim 1 wherein each of the mobile communications devices includes client software residing thereon for executing the interactive marketing application, and wherein the signal activates the client software to download or update the interactive marketing application or portions thereof from the server computer system.

3. The method of claim 2 further comprising identifying and retrieving personalized content from a backend system, and delivering the personalized content with the interactive marketing application to the mobile communications device.

4. The method of claim 3 wherein the backend system comprises a CRM database, a CMS system, an ad server, or a marketing campaign management system.

5. The method of claim 1 wherein establishing bidirectional communications between the user and the entity includes relaying data between the mobile communications device and a backend system via the server computer system.

6. The method of claim 1 further comprising tracking user response to the interactive marketing application for evaluating the marketing campaign, initiating further marketing activities, or developing a user profile.

7. The method of the claim 1 further comprising adapting the marketing campaign in accordance with data received from tracking user response to the interactive marketing application.

8. The method of claim 1 wherein transmitting a signal to proactively launch an interactive application comprises transmitting a signal in accordance with a predetermined schedule.

9. The method of claim 1 further comprising launching a subsequent related marketing application on the mobile communications device in response to user interaction with the marketing application.

10. The method of claim 1 further comprising facilitating communication between the user and the entity via an alternative communications channel using the mobile communications device.

11. The method of claim 10 wherein the alternative communications channel comprises a telephone connection, Internet connection, a messaging system, or a WAP portal.

12. The method of claim 1 wherein transmitting a signal comprises transmitting a message in silent mode to the mobile communications device.

13. A system for conducting a marketing campaign directed at users of mobile communications devices, comprising a server communicating with the mobile communications devices over a wireless network, the server identifying a targeted subset of the users of the mobile communications devices based on their user profiles to receive and execute a given one of a plurality of interactive marketing applications; and for each of the targeted subset of users, the server (i) transmitting a signal with initial information relating to an application over the wireless communications network to a mobile communications device operated by the user to proactively launch the given one of the interactive marketing applications on the mobile communications device; and (ii) establishing bidirectional communications between the user and an entity conducting the marketing campaign responsive to user interaction with the interactive marketing application.

14. The system of claim 13 wherein each of the mobile communications devices includes client software residing thereon for executing the interactive marketing application, and wherein the signal activates the client software to download or update the interactive marketing application or portions thereof from the server computer system.

15. The system of claim 14 wherein the server communicates with a backend system for receiving personalized content from a backend system, wherein the server delivers the personalized content with the interactive marketing application to the mobile communications device.

16. The system of claim 15 wherein the backend system comprises a CRM database, a CMS system, an ad server, or a marketing campaign management system.

17. The system of claim 13 wherein the server system establishes bidirectional communications between the user and the entity by relaying data between the mobile communications device and the backend system.

18. The system of claim 13 wherein the server further tracks user response to the interactive marketing application for evaluating the marketing campaign, initiating further marketing activities, or developing a user profile.

19. The system of the claim 13 wherein the server adapts the marketing campaign in accordance with data received from tracking user response to the interactive marketing application.

20. The system of claim 13 wherein the server transmits the signal in accordance with a predetermined schedule.

21. The system of claim 13 wherein the server launches a subsequent related marketing application on the mobile communications device in response to user interaction with the marketing application.

22. The system of claim 13 wherein the server facilitates communication between the user and the entity via an alternative communications channel using the mobile communications device.

23. The system of claim 22 wherein the alternative communications channel comprises a telephone connection, Internet connection, a messaging system, or a WAP portal.

24. The system of claim 13 wherein the server transmits the signal in silent mode to the mobile communications device.
